(19) United States
(12) Patent Application Publication
(10) Pub. No.: US 2003/0115608 A1
(43) Pub. Date: Jun. 19, 2003

(54) SIGNAL DISTRIBUTION METHOD AND APPARATUS

(76) Inventors: RICHARD L. ARMSTRONG, GAITHERSBURG, MD (US); MICHAEL J. SCOTT, IJAMSVILLE, MD (US); WALTER R. KEPLEY, GAITHERSBURG, MD (US); THOMAS JACKSON, FREDERICK, MD (US)

Correspondence Address: HUGHES ELECTRONICS CORPORATION, PATENT DOCKET ADMINISTRATION, BLDG 001 M/S A109, P O BOX 956, EL SEGUNDO, CA, 902450956

(21) Appl. No.: 09/292,707

(22) Filed: Apr. 15, 1999

Related U.S. Application Data
(60) Provisional application No. 60/081,916, filed on Apr. 16, 1998.

(51) Int. Cl. H04N 7/18; H04N 7/16; H04J 1/00

(52) U.S. Cl. 725/78; 725/82; 725/143; 370/343

(57) ABSTRACT

A signal distribution method and apparatus which distribute higher quality signals in addition to standard signals, thereby enabling reception of higher quality picture and sound at a remote reception appliance. The method and apparatus also distribute digitally compressed signals in addition to standard signals, which also enables reception of higher quality picture and sound at the remote reception appliance. Finally, the method and apparatus distribute the higher quality signals and the digitally compressed signals to multiple reception appliances, located in a single family home environment or to multiple reception appliances within a multiple dwelling unit.

### RELATED APPLICATIONS

This application claims priority from U.S. Provisional Patent Application Serial No. 60/081,916 filed Apr. 16, 1998, entitled “Multi-set Remote Integrated Receiver Decoder (IRD) System-Digital and Analog Distribution.”

### BACKGROUND OF THE INVENTION

1. Field of the Invention

The present invention relates to the distribution of signals, and more particularly, to the distribution of television and Internet signals of different types, to multiple reception appliances.

2. Description of the Related Art

Conventionally, analog terrestrial or cable broadcast TV services are provided as television signal inputs to TV appliances. The current, widely used, method to provide such signals to TV appliances is to modulate the video and audio signals together onto a single RF carrier in the UHF or VHF spectrum to produce a combined modulated audio/video signal.

The advent of direct broadcast satellite (DBS) delivered TV services enables higher quality video and audio signals to be achievable on a TV appliance (for example, a standard definition television, a high definition television, a standard definition VCR, a personal computer monitor, an audio decoder, or an audio interface). Higher quality video signals include s-video, component video, and composite video. The conventional combined audio and video modulation method significantly degrades the quality of the higher quality video signals by the time they reach the TV appliance.

In order to fully benefit from the improved quality of the DBS delivered TV service, it is desirable to separately modulate each of the s-video, the composite video, and the component video from the stereo (left/right) baseband audio and provide each of the higher quality video signals, the stereo (left/right) baseband audio and the combined modulated audio/video to a distribution device, which supplies all of the desired signals to the TV appliance. In an environment where the DBS receiver is remotely located (in a different room or over ten feet) from the TV appliance, there is currently no cost-effective technique for separately modulating and distributing the s-video, the composite video, or the component video, in combination with the stereo (left/right) baseband audio and the combined modulated audio/video, to TV appliances.

In order to further benefit from the improved quality of the DBS delivered TV services, it is also desirable to provide digitally compressed video and audio signals in addition to the combined modulated audio/video, to a distribution device capable of converting these digital signals into a form suitable for display on a TV appliance. Again, in an environment where the DBS receiver is remotely located from the TV appliance, there is to date, no practical way to distribute the digitally compressed signals to the TV appliance.

Further, the conventional use of DBS delivered TV services only includes the distribution of the DBS TV signal, in s-video, composite or component video form, to a single reception appliance; it does not allow for distribution of the higher quality video service to multiple appliances within the same household, or multiple reception appliances within a multiple dwelling unit (MDU).

### SUMMARY OF THE INVENTION

The present invention solves the above-identified problems with the distribution of DBS delivered TV services. In particular, in an environment where the DBS receiver is remotely located from a reception appliance, the present invention separately modulates s-video, composite, and component video signals from the stereo baseband audio signals and distributes the s-video, composite video, and component video in addition to stereo baseband audio and combined modulated audio/video, thereby enabling reception of higher quality picture and sound at the remote reception appliance.

Additionally, in an environment where the DBS receiver is remotely located from the reception appliance, the present invention distributes digitally compressed audio and video signals, in addition to the combined modulated audio/video, thereby enabling reception of a higher quality picture and sound at the remote reception appliance.

The present invention also distributes s-video, component video, composite video, and digitally compressed audio and video signals to multiple reception appliances, either located in a single family home environment or within a multiple dwelling unit, when the DBS receiver is remotely located from the multiple reception appliances.

### BRIEF DESCRIPTION OF THE DRAWINGS

FIG. 1 illustrates signal distribution apparatus in one general embodiment of the present invention.

FIG. 2 illustrates a signal distribution method in one general embodiment of the present invention.

FIG. 3 illustrates a transmission and reception system including the signal distribution apparatus of the present invention.

FIG. 4 illustrates the distribution unit and the reception appliances of FIG. 3 in more detail.

FIG. 5 illustrates the analog demultiplexer of FIG. 4 in more detail.

FIG. 6 illustrates another embodiment of the distribution unit and the reception appliances of FIG. 4.

FIG. 7 illustrates the digital demultiplexer of FIG. 6 in more detail.

### DETAILED DESCRIPTION OF THE PREFERRED EMBODIMENT

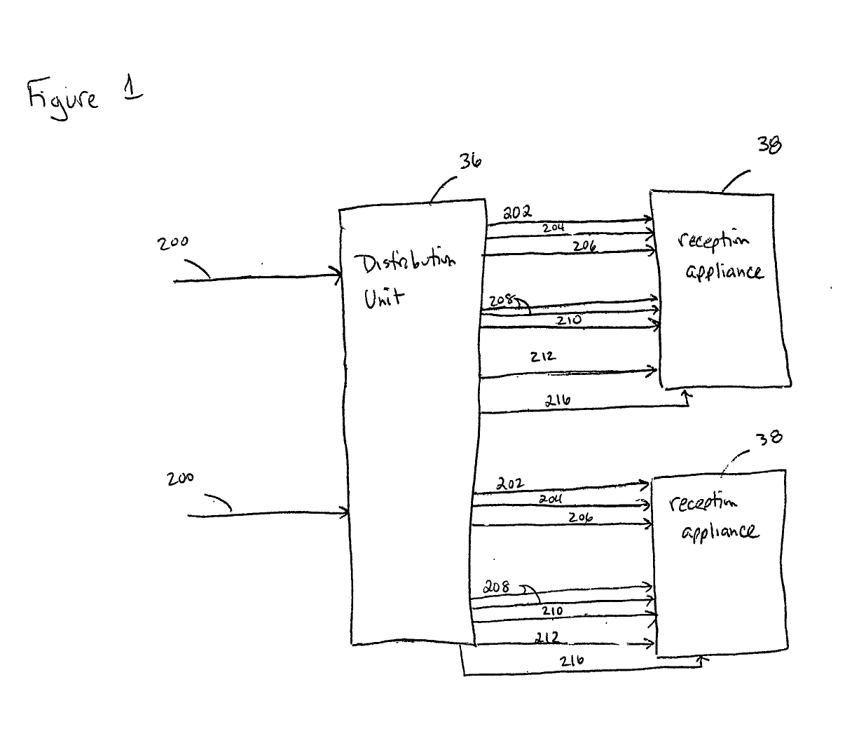

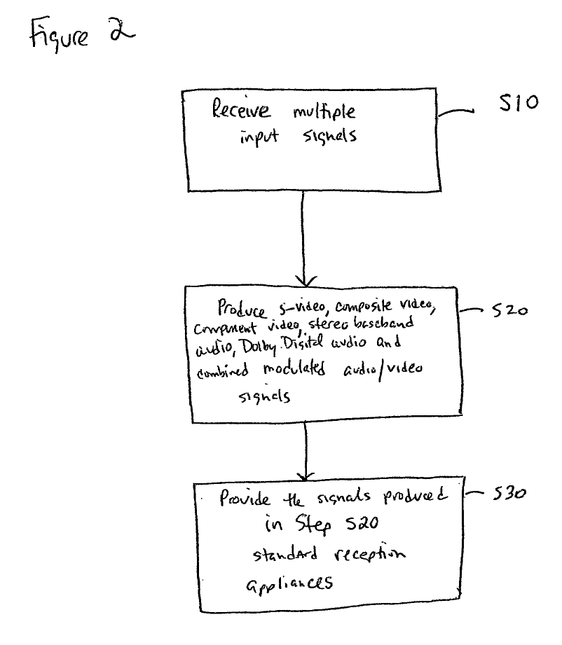

The present invention will be generally discussed with reference to FIGS. 1-2. The present invention is generally directed to a signal distribution apparatus. As illustrated in FIG. 1, the distribution unit 36 receives two input signals 200. The distribution unit 36 outputs separate s-video 202, composite video 204, and component video 206. The distribution unit 36 also outputs separately modulated stereo (left/right) baseband audio 208, Dolby Digital audio 210, as well as, the conventional combined modulated audio/video 212, to a corresponding number of reception appliances 38.

The input signals may be delivered via a number of different networks, such as satellite, coaxial cable, hybrid fiber/coaxial (HFC) cable, multi-channel multi-point distribution system (MMDS), local multi-point distribution system (LMDS), terrestrial digital TV in accordance with the Advanced Television Standards Committee (ATSC) specifications, and Digital Subscriber Line (DSL) and its variants, for example. Additionally, the reception appliance 38 could include any audio/video signal reception device, such as a standard definition TV, a high definition TV, a standard definition VCR, a standard definition personal computer (PC) monitor, audio decoder, audio interface, or other PC-like or internet/web terminal.

Further, although FIG. 1 illustrates two input signals and two reception appliances, the number of input signals and corresponding number of reception appliances 38 could also be any number greater than two. Further, the reception appliances 38 illustrated in FIG. 1, could be located within the same single family dwelling, or within different units of a multiple dwelling unit (MDU), such as an apartment complex, condominium complex, hotel, motel, hospital, retirement home, or commercial office block. Additionally, although FIG. 1 illustrates distributing different types of audio and video information, the distribution unit 36 may also be utilized to distribute other information as well, including internet information 216, such as web pages, newsgroups and electronic mail.

In addition to the conventional modulated audio/video information, the video data provided by the distribution unit 36 includes, but is not limited to, S-video, composite video, and component video. The audio data provided by the distribution unit 36 includes, but is not limited to, stereo (left/right) baseband audio and compressed audio including but not limited to PCM and Dolby Digital in accordance with IEC-60958 (also commonly referred to as SPDIF in the consumer electronics industry). Further, the format of the various video signals could be any one of NTSC, PAL, SECAM or any other worldwide standard format.

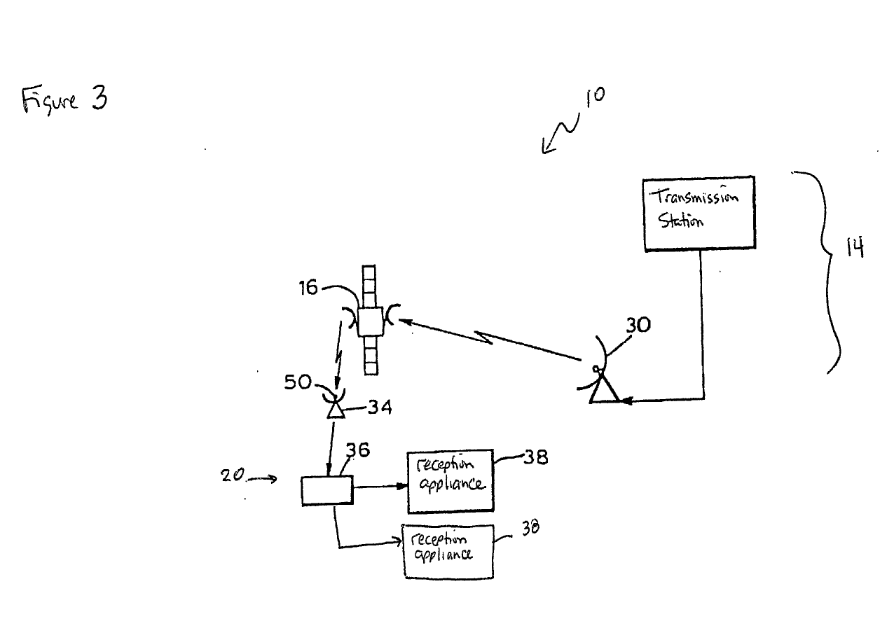

The present invention is also generally directed to a signal distribution method. As illustrated in FIG. 3, step S10 of the method includes receiving multiple input signals 200. Step S20 includes producing a corresponding number of separately modulated s-video 202, composite video 204, and component video signals 206; producing a separately modulated stereo baseband audio signal 208, Dolby Digital audio signal 210; and the conventional combined modulated audio/video signal 212. Step S30 includes providing one or more of the signals produced in Step S20 to a corresponding number of reception appliances 38.

The present invention, in several preferred embodiments, will be discussed below with reference to FIGS. 3-7.

FIG. 3 is a block diagram of a transmission and reception system 10 embodying the features of the present invention. The transmission and reception system 10 includes a transmission station 14, a relay 16, and a plurality of receiver stations, one of which is shown at reference numeral 20. A wireless air link provides the communication medium between the transmission station 14, the relay 16, and the receiver station 20. The transmission station 14 includes an uplink satellite antenna 30. The relay 16 is at least one geosynchronous satellite. The receiver station 20 includes a satellite reception antenna/dish 34, a low-noise block (LNB) 50, connected to the dish 34, a distribution unit 36 connected to the LNB 50, and at least two reception appliances 38, connected to the distribution unit 36.

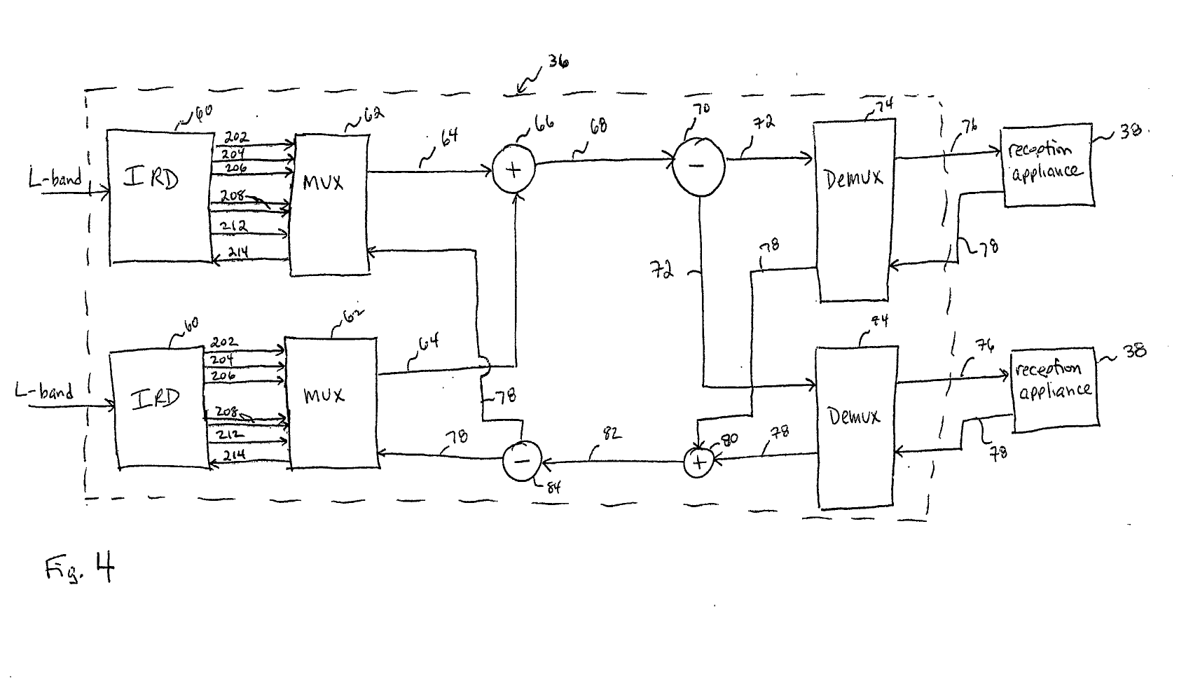

FIG. 4 illustrates the distribution unit 36 and the reception appliances 38 in more detail. The distribution unit 36 includes two integrated receiver decoders (IRD) 60, each of which receives an L-band signal from the LNB 50. The integrated receiver decoders (IRD) 60 output an S-video signal 202, a composite video signal 204, a component video signal 206, stereo left/right audio signals 208, and a combined modulated audio/video signal 212 and receive a remote control RF (or IR) signal 214 from corresponding multiplexers 62. Multiplexers 62 multiplex the various audio and video signals received from the corresponding IRD 60 to produce a multiformat stream for a selected channel 64. In the multiformat stream for a selected channel 64, the s-video signal, the component video signal, and the composite video signal, and the stereo baseband audio signal are separately modulated on available TV frequencies along with the combined modulated audio/video signal. A combiner 66 receives the multiformat stream for a selected channel 64 from each of the multiplexers 62 and combines these signals to produce a multiformat stream for multiple selected channels 68. A separator 70 receives the multiformat stream for multiple selected channels 68 and divides the stream 68 again into multiformat streams for a selected channel 72, which are supplied to corresponding demultiplexers 74. Each demultiplexer 74 provides the desired signals (s-video 202, composite video 204, component video 206, stereo baseband audio 208, combined modulated audio/video 212) to its corresponding reception appliance 38, depending on the capabilities of the reception appliance 38, as signal 76.

Each reception appliance 38 is equipped with a RF (or IR) based remote control for channel selection. The reception appliance 38 outputs a signal 78, which is passed through the multiplexer 74 and is combined with other signals by combiner 80. Combiner 80 combines the signals 78 into signal 82 and passes signal 82 to separator 84. Separator 84 divides the signals into individual signals 78 again which are passed through multiplexer 62 and utilized to control channel selection in the IRDs 60.

In a preferred embodiment, the IRD 60 illustrated in FIG. 4 is a conventional settop box, such as a DSL or HFC with a conventional coaxial return channel. In the embodiment in FIG. 4, elements 60, 62, 66, and 84 are physically located with the DBS receiver; elements 74 are physically located with their corresponding reception appliance 38; and elements 70 and 80 can be located wherever convenient. In this manner, each of the different types of higher quality audio and video signals can be separately modulated at the DBS receiver, before transmission to the reception appliance 38, in order to ensure a higher quality signal is received at each reception appliance 38.

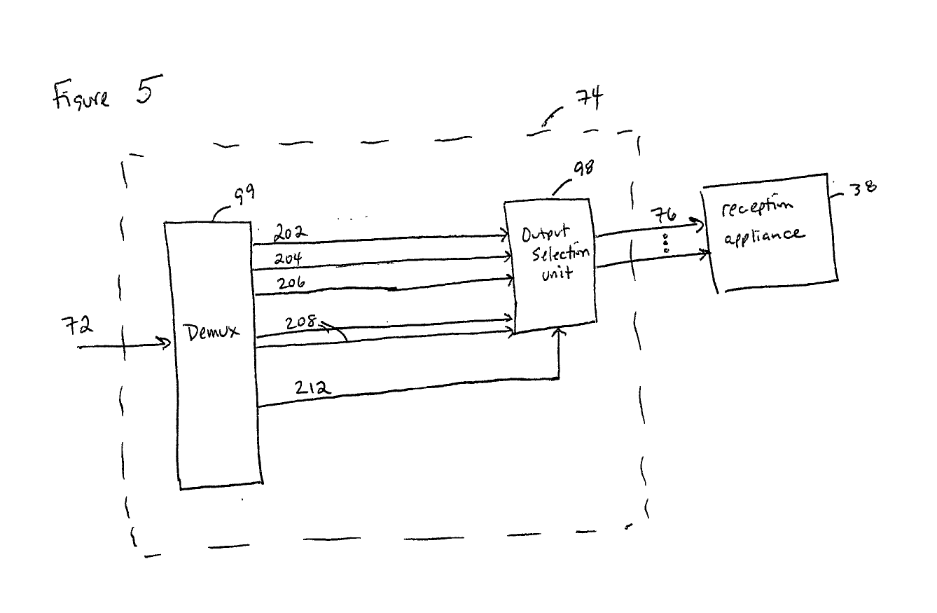

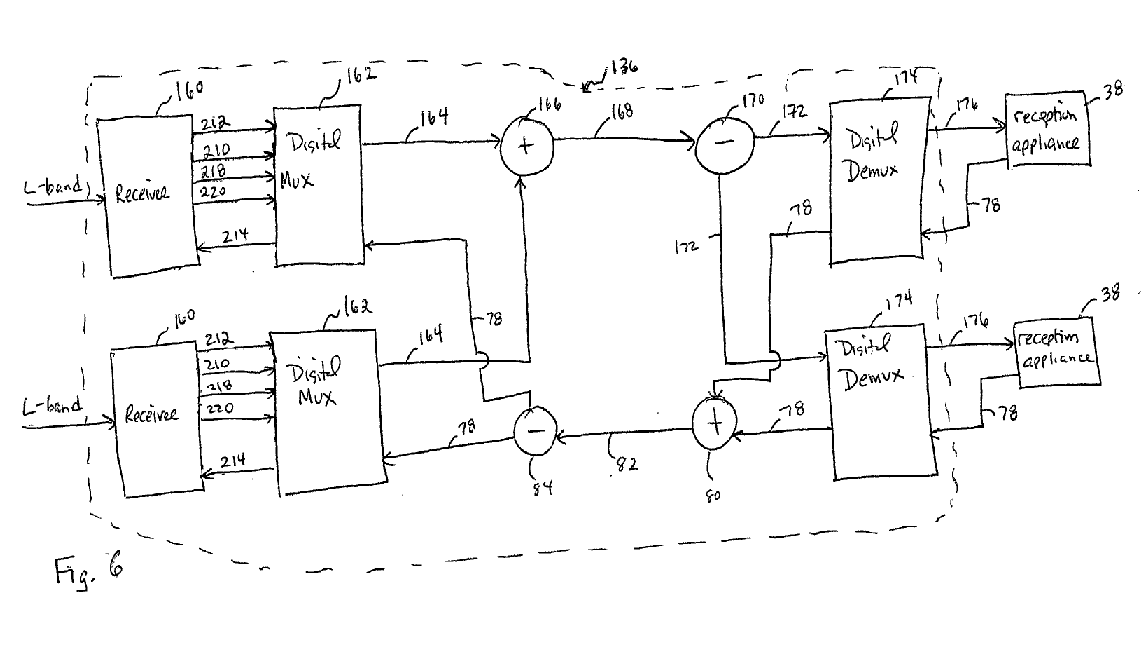

FIG. 5 is a more detailed block diagram of the analog demultiplexer 74 of FIG. 6. An analog demultiplexer 99 receives the multiformat stream for a selected channel 72 and demultiplexes the stream 72 into s-video 202, composite video 204, component video 206, stereo baseband audio 208, and combined modulated audio/video 212. The s-video 202, composite video 204, component video 206, stereo baseband audio signals 208, and the combined modulated audio/video 212, are input to an output selection unit 98, which provides the desired signals to the corresponding reception appliance 38, depending on the capabilities of the reception appliance 38, as signal 176.

FIG. 6 illustrates a second embodiment of the distribution unit 36 of FIG. 4. In particular, the distribution unit 136 of FIG. 6 includes two receivers 160, each of which receives an L-band signal from the LNB 50. The receivers 160 output a digitally MPEG compressed audio/video signal 212, a Dolby Digital or PCM audio bitstream signal 210, program guide information 218, and control information 220, and receive a remote control RF (or IR) signal 214 from corresponding digital multiplexers 162. Digital multiplexers 162 modulate and multiplex the signals received from the corresponding receiver 162 to produce a multiplexed stream for a selected channel 164. A combiner 166 receives the multiplexed stream for a selected channel 164 from each of the digital multiplexers 162 and combines these signals to produce a multiplexed stream for multiple selected channels 168. A separator 170 receives the multiplexed stream for multiple selected channels 168 and divides the stream 168 again into multiplexed streams for a selected channel 172, which are supplied to corresponding digital demultiplexers 174. Each digital demultiplexer 174 decodes and provides the desired signals (the combined modulated audio/video 212, s-video 202, composite video 204, component video 206, stereo baseband audio 208, Dolby Digital audio 210, program guide information 218, and control information 220) to its corresponding reception appliance 38, depending on the capabilities of the reception appliance 38, as signal 176.

Each reception appliance 38 is equipped with RF (or IR) based remote control for channel selection. The reception appliance 38 outputs a signal 78, which is passed through the digital demultiplexer 174 and is combined with other signals by combiner 80. Combiner 80 combines the signal 78 into signal 82 and passes signal 82 to separator 84. Separator 84 divides the signals into individual signals 78 again, which are passed through digital multiplexers 162 and utilized to control channel selection in the receivers 160.

In the embodiment in FIG. 6, elements 160, 162, 166, and 184 are physically located with the DBS receiver; elements 174 are physically located with their corresponding reception appliance 38; and elements 170 and 180 can be located wherever convenient. In this manner, the audio and video signals can be transmitted from the DBS receiver location to the reception appliance location in digital form, thereby reducing degradation due to transmission loss.

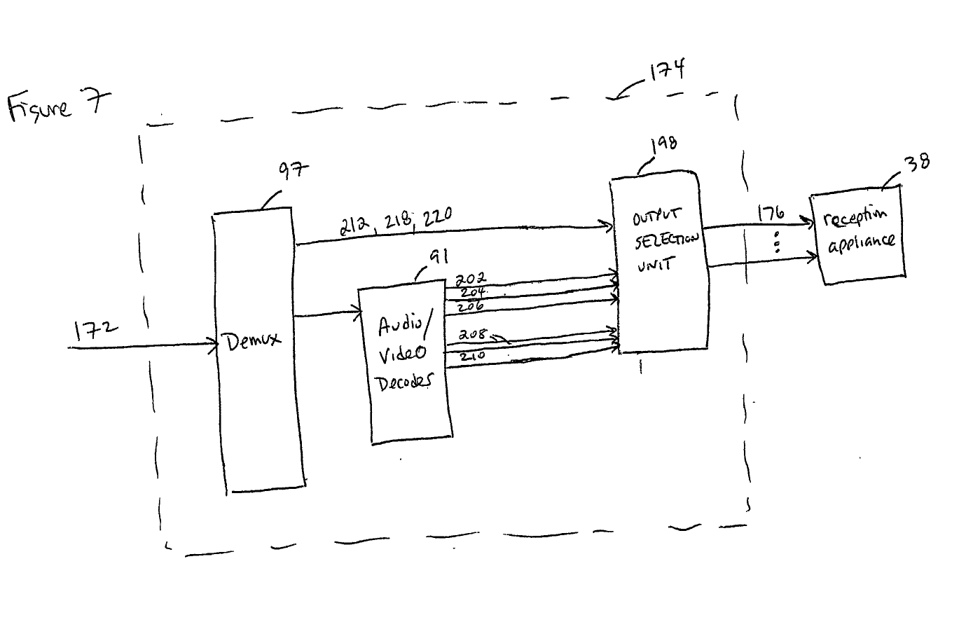

FIG. 7 is a more detailed block diagram of the digital demultiplexer 174 of FIG. 6. A digital demultiplexer 99 receives the multiplexed stream for a selected channel 172 and separates the combined modulated audio/video signal 212 and the program guide information 218 and control information 220 from the remainder of stream 172, which is represented as compressed audio/video bitstream 180. The compressed audio/video bitstream 180 is input to audio/video decoder 91 and decoded into s-video 202, composite video 204, component video 206, stereo baseband audio 208, and a Dolby Digital or PCM audio bitstream 210 in accordance with IEC 60958 format. The combined modulated audio/video signal 212, the program guide information 218, the control information 220, the s-video 202, the composite video 204, the component video 206, the stereo baseband audio 208, and the Dolby Digital audio bitstream 210 are input to an output selection unit 198, which provides the desired signals to the corresponding reception appliance 38, depending on the capabilities of the reception appliance 38, as signal 176.

Although FIGS. 1, 4 and 6 have been described separately, any combination of audio, video, and internet signals could be made available to any reception appliance. Further, although FIGS. 1 and 4-7 have been illustrated and described as including discrete elements, any number of these functions could be performed by common hardware or software elements, except where such combination destroys the purpose of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of distributing signals comprising the steps of:
multiplexing a first signal of a first type and a second signal of a second type, different from the first type, to produce a multiplexed signal, where constituents of the first signal are separately modulated; and
demultiplexing the multiplexed signal so that at least one of the first signal and the second signal is supplied to at least one reception appliance.

2. The method of claim 1, wherein the first signal and the second signal include TV information or internet information.

3. The method of claim 1, wherein the internet information includes web page, news group, or electronic mail information.

4. The method of claim 1, wherein the constituents of the first signal include analog audio and video signals and the second signal includes a combined modulated audio/video TV signal.

5. The method of claim 1, wherein the first signal includes a digitally compressed video and audio TV signal and the second signal includes a combined modulated audio/video TV signal.

6. The method of claim 4, wherein the second signal is one of a satellite, coaxial cable, hybrid fiber/coaxial (HFC), wireless, MMDS, LMDS, DSL or variant, and ATSC TV signal.

7. The method of claim 5, wherein the second signal is one of a satellite, coaxial cable, hybrid fiber/coaxial, wireless, MMDS, LMDS, DSL or variant, and ATSC TV signal.

8. The method of claim 4, further comprising the steps of:
receiving the first signal from a direct broadcast satellite service and receiving the second signal from an analog terrestrial or cable broadcast TV service, wherein a receiver for the direct broadcast satellite service is remotely located from the at least one reception appliance.

9. The method of claim 5, further comprising the steps of:
receiving the first signal from a direct broadcast satellite service and receiving the second signal from an analog terrestrial or cable broadcast TV service, wherein a receiver for the direct broadcast satellite service is remotely located from the at least one reception appliance.

10. The method of claim 4, wherein each of the at least one reception appliances is a television, VCR, personal computer, an audio decoder, an audio interface, or internet/web terminal.

11. The method of claim 5, wherein each of the at least one reception appliances is a television, VCR, personal computer, an audio decoder, an audio interface, or internet/web terminal.

12. The method of claim 4, wherein the at least one reception appliance includes multiple appliances within a single dwelling.

13. The method of claim 5, wherein the at least one reception appliance includes multiple appliances within a single dwelling.

14. The method of claim 4, wherein the at least one reception appliance includes multiple appliances within a multiple dwelling unit.

15. The method of claim 5, wherein the at least one reception appliance includes multiple appliances within a multiple dwelling unit.

16. The method of claim 5, wherein the digitally compressed video and audio TV signal is compressed utilizing MPEG2 or other digital compression technology.

17. An apparatus for distributing signals comprising:
a multiplexer for multiplexing a first signal of a first type and a second signal of a second type, different from the first type, to produce a multiplexed signal, where constituents of the first signal are separately modulated; and
a demultiplexer for demultiplexing the multiplexed signal so that at least one of the first signal and the second signal is supplied to at least one reception appliance.

18. The apparatus of claim 17, wherein the first signal and the second signal include TV information or internet information.

19. The apparatus of claim 17, wherein the internet information includes web page or HTML formatted data, news group, or electronic mail information.

20. The apparatus of claim 17, wherein the constituents of the first signal include analog audio and video signals and the second signal includes a combined modulated audio/video TV signal.

21. The apparatus of claim 17, wherein the first signal includes a digitally compressed video and audio TV signal and the second signal includes a combined modulated audio/video TV signal.

22. The apparatus of claim 19, wherein the second signal is one of a satellite, coaxial cable, hybrid fiber/coaxial, wireless, MMDS, LMDS, DSL or variant, and ATSC TV signal.

23. The apparatus of claim 20, wherein the second signal is one of a satellite, coaxial cable, hybrid fiber/coaxial, wireless, MMDS, LMDS, DSL or variant, and ATSC TV signal.

24. The apparatus of claim 19, further comprising:
a receiving unit for receiving the first signal from a direct broadcast satellite receiver and receiving the second signal from an analog terrestrial or cable broadcast TV service, wherein the direct broadcast satellite receiver is remotely located from the at least one reception appliance.

25. The apparatus of claim 20, further comprising:
a receiving unit for receiving the first signal from a direct broadcast satellite receiver and receiving the second signal from an analog terrestrial or cable broadcast TV service, wherein the direct broadcast satellite receiver is remotely located from the at least one reception appliance.

26. The apparatus of claim 19, wherein each of the at least one reception appliances is a television, VCR, personal computer, audio decoder, audio interface, or internet/web terminal.

27. The apparatus of claim 20, wherein each of the at least one reception appliances is a television, VCR, personal computer, audio decoder, audio interface, or internet/web terminal.

28. The apparatus of claim 19, wherein the at least one reception appliance includes multiple reception appliances within a single dwelling.

29. The apparatus of claim 20, wherein the at least one reception appliance includes multiple reception appliances within a single dwelling.

30. The apparatus of claim 19, wherein the at least one reception appliance includes multiple reception appliances within a multiple dwelling unit.

31. The apparatus of claim 20, wherein the at least one reception appliance includes multiple reception appliances within a multiple dwelling unit.

32. The apparatus of claim 20, wherein the digitally compressed video and audio TV signal is compressed utilizing MPEG2 or other digital compression technology.

33. A propagated signal comprising:
a first signal segment of a first type; and
a second signal segment of a second type, different from the first type;
wherein constituents of the first signal segment are separately modulated and the first signal segment and the second signal segment are multiplexed together for transmission and demultiplexed upon receipt so that at least one of the first signal segment and the second signal segment is supplied to at least one reception appliance.

34. The propagated signal of claim 33, wherein the first signal segment and the second signal segment include TV information or internet information.

35. The propagated signal of claim 33, wherein the internet information includes web page or HTML formatted data, news group, or electronic mail information.

36. The propagated signal of claim 33, wherein the constituents of the first signal segment include analog audio and video signals and the second signal segment includes a combined modulated audio/video TV signal.

37. The propagated signal of claim 33, wherein the first signal segment includes a digitally compressed video and audio TV signal and the second signal segment includes a combined modulated audio/video TV signal.

38. The propagated signal of claim 36, wherein the second signal segment is one of a satellite, coaxial cable, hybrid fiber/coaxial, wireless, MMDS, LMDS, DSL or variant, and ATSC TV signal.

39. The propagated signal of claim 37, wherein the second signal segment is one of a satellite, coaxial cable, hybrid fiber/coaxial, wireless, MMDS, LMDS, DSL or variant, and ATSC TV signal.

40. The propagated signal of claim 36, wherein the first signal segment originates from a direct broadcast satellite service and the second signal segment originates from an analog terrestrial or cable broadcast TV service, wherein a receiver of the direct broadcast satellite service is remotely located from the at least one reception appliance.

41. The propagated signal of claim 37, wherein receiving the first signal from a direct broadcast satellite service and receiving the second signal from an analog terrestrial or cable broadcast TV service, wherein a receiver of the direct broadcast satellite service is remotely located from the at least one reception appliance.

42. The propagated signal of claim 36, wherein each of the at least one reception appliances is a television, VCR, personal computer, audio decoder, audio interface, or internet/web terminal.

43. The propagated signal of claim 37, wherein each of the at least one reception appliances is a television, VCR, personal computer, audio decoder, audio interface, or internet/web terminal.

44. The propagated signal of claim 36, wherein the at least one reception appliance includes multiple appliances within a single dwelling.

45. The propagated signal of claim 37, wherein the at least one reception appliance includes multiple appliances within a single dwelling.

46. The propagated signal of claim 36, wherein the at least one reception appliance includes multiple appliances within a multiple dwelling unit.

47. The propagated signal of claim 37, wherein the at least one reception appliance includes multiple appliances within a multiple dwelling unit.

48. The propagated signal of claim 37, wherein the digitally compressed video and audio TV signal is compressed utilizing MPEG2 or other digital compression technology.

49. An apparatus comprising:
a plurality of multiplexers, each for multiplexing a first signal of a first type and a second signal of a second type, different from the first type, to produce a plurality of multiplexed signal, where constituents of the first signal are separately modulated; and
a plurality of demultiplexers, each for demultiplexing a corresponding one of the plurality of multiplexed signal so that at least one of the first signal and the second signal is supplied to a corresponding one of a plurality of reception appliances.

50. The apparatus of claim 49, wherein the constituents of the first signal include analog audio and video signals and the second signal includes a combined modulated audio/video TV signal.

51. The apparatus of claim 49, wherein the first signal includes a digitally compressed video and audio TV signal and the second signal includes a combined modulated audio/video TV signal.
